(19) United States
(12) Patent Application Publication
(10) Pub. No.: US 2019/0153736 A1
(43) Pub. Date: May 23, 2019

(54) Replicating Repair Patch

(71) Applicant: Scott Gungel, Littleton, CO (US)

(72) Inventor: Scott Gungel, Littleton, CO (US)

(21) Appl. No.: 16/197,482

(22) Filed: Nov. 21, 2018

Related U.S. Application Data
(60) Provisional application No. 62/589,564, filed on Nov. 22, 2017.

(51) Int. Cl. E04G 23/02; B29C 73/10

(52) U.S. Cl. CPC E04G 23/0296; F16L 55/1683; B29C 73/10

(57) ABSTRACT

A repair patch for repairing holes, cracks or other types of damage that can replicate a surface (eg: drywall, wall, ceiling, door) by rubbing on the replicating repair patch as it rests on the undamaged surface area of an inanimate object. The patch is then applied over the damaged area of the inanimate object and rubbed around the edges to create a textured repair of the damaged surface of the inanimate object. The repair patch includes a sheet, circular or of any any other shape, made of aluminum or aluminum foil with a paper covered adhesive backer.

### BACKGROUND OF THE INVENTION

It is common in the construction trade to have to create channels and access holes in drywall and other surfaces to insert data lines, run electrical wiring and to install pipes for plumbing. Repair patches are commercially available for repairing holes, or other defects, so that the holes or defects may be completely covered without a trace of its presence, after a plastering compound such as joint compound has been applied then a texture compound sprayed over it to hide the repair. This process normally takes hours or days to complete since it involves putting a backer into the hole and then covering it with joint compound to be left to dry for 24 hours. The compound is then sanded and texture must be sprayed over the repaired are to hide the patch. The sprayed texture normally takes about 8 hours to dry and then the repaired area must be primed and painted. This is a multi day process and if the joint compound is not applied and sanded correctly there will be a hump in the area where the repair was completed and the texture may not match perfectly either.

Thus, there is a need for a repair system that allows an individual to repair holes in inanimate objects such as drywall, wood, and exterior siding without performing the long and arduous aforementioned tasks. Moreover, there is a desperate need for a cosmetic repair system that does not require a professional tradesman but allows all individuals to repair holes quickly and efficiently.

### BRIEF SUMMARY OF THE INVENTION

In accordance with this invention, a repair patch patch is provided, which comprises: aluminum or aluminum foil, circular or of any other shape, with a paper covered, pressure sensitive adhesive backer on one side. The repair patch is placed against the undamaged surface of an inanimate object and rubbed vigorously to imprint the texture of the surface into the aluminum. The paper covering the adhesive backer is removed and the adhesive side is pointed toward the surface of the inanimate object and centered over the hole, then placed onto the surface thereby covering the hole. Rubbing around the edges of the repair patch the aluminum or aluminum foil bonds to the surface and visually repairs the hole by replicating the surface of the inanimate object. The thin property of the aluminum or aluminum foil creates a barely noticeable edge to the repair and once it is painted it blends seamlessly into the surface of the inanimate object.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope.

FIG. 1 illustrates an example of the texture replicating repair patch;

FIG. 2 illustrates a side view of an inanimate object with a hole on which a repair patch can be used;

FIG. 3 illustrates the repair patch being rubbed against the undamaged surface of an inanimate object to show how a surface texture is imprinted into the repair patch;

FIG. 4 illustrates the removal of the paper covering the adhesive backer in preparation for adhesion over the hole in the surface of the inanimate object;

FIG. 5 illustrates the completion of the repair by rubbing the repair patch around the edges, away from the hole, to adhere the patch to the surface of the inanimate object. The process of rubbing the patch around the edges has the effect of retaining the textured imprint in the center of the patch while further imprinting the surface of the inanimate object into the edges of the repair patch to have it blend seamlessly into the wall.

### DETAILED DESCRIPTION OF THE INVENTION

The present invention is comprised of aluminum or aluminum foil, circular or of any other shape, with a paper covered, pressure sensitive adhesive backer on one side. Reference will now be made to the figures wherein like structures will be provided with like reference designations. It is understood that the figures are diagrammatic and schematic representations of some embodiments of the invention, and are not limiting of the present invention, nor are they necessarily drawn to scale.

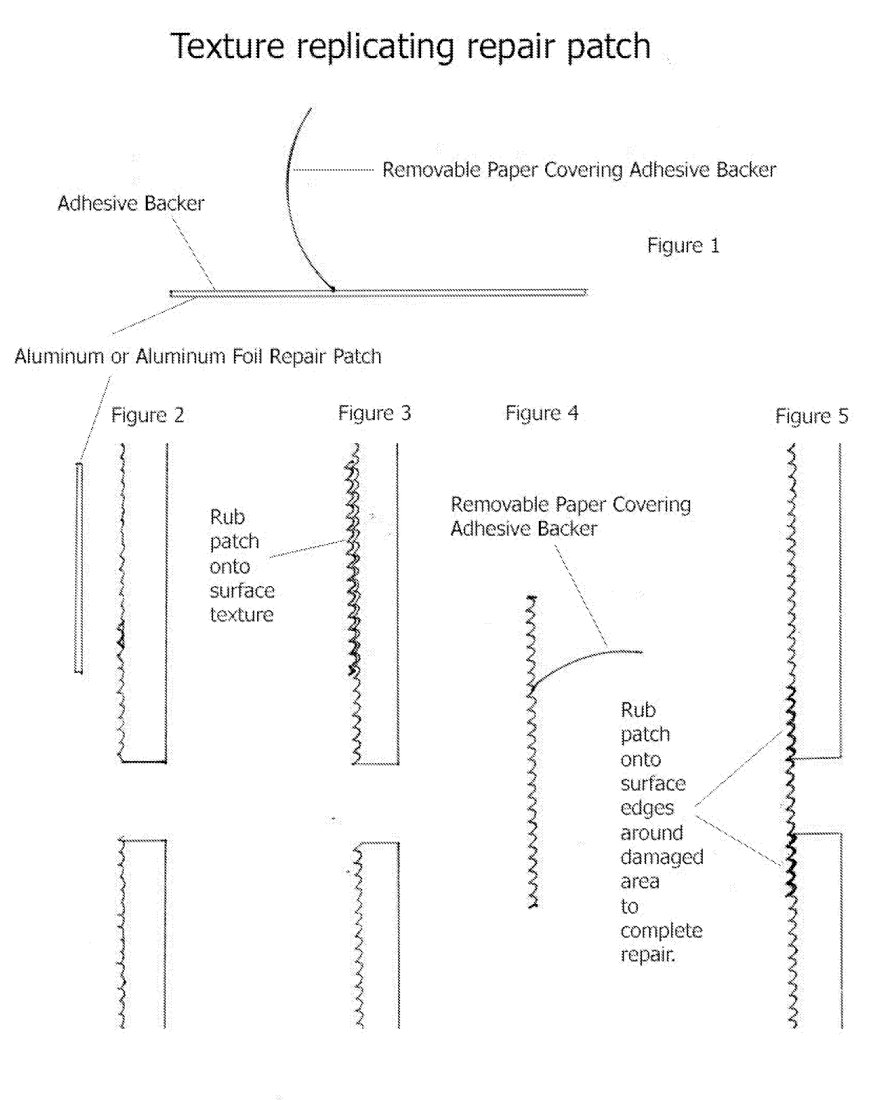

FIG. 1 illustrates an example of the repair patch. The repair patch can be employed in a wide variety of applications. For example, the repair wrap may be used to repair, temporarily or permanently, items that have holes. I.e., if an object has a hole that needs to be covered temporarily such as a hole in glass, the patch provides a quick and simple repair. Additionally or alternatively, the repair patch may be used to perform permanent repairs in drywall or exterior siding by replicating the texture of the surface of an inanimate object and forming a strong adhesive bond to the surface that readily accepts paint.

General areas of application include construction, aviation, and home improvement. For example, the repair wrap may be used in connection with a variety of different materials. Such materials include, but are not limited to, wood, metal, glass, plastic, composites, fiberglass, ceramic, concrete, and combinations of any of the foregoing. E.g., the repair wrap may be used to repair, temporarily or permanently, items such as drywall, doors, wood, composites, exterior siding, cabinets, aviation fuselages, and furniture, various specialized applications of the repair patch are also possible.

Properties of the Repair Patch:

1. Self-adhesive properties make it a simple and quick repair;

2. Can be applied easily, without training;

3. Water resistant and rustproof;

4. Permanently affixed, it is not meant to come off easily;

5. Eliminates the need for joint compound and the spraying of texture;

6. Requires no extended dry time or messy sanding; and

7. Strong adhesive bonds firmly to any surface regardless and the thin material forms easily to any surface. FIG. 2 shows an example of an inanimate object with a hole that may be repaired by the repair wrap. The surface material is irrelevant since the texture of any type of surface can be replicated with the thin aluminum when pressure is applied.

FIG. 3 shows an example of an inanimate object that has a hole and how the patch is used on the same surface in an undamaged area to replicate the texture of the inanimate object. By placing the patch on an undamaged area of the inanimate object, the patch copies the texture of the inanimate object so that when it's placed over the hole it appears as an undamaged surface.

FIG. 4 shows the removal of the paper covering the adhesive backer in preparation for placement over the hole in the inanimate object.

FIG. 5 shows the areas where the repair patch is rubbed on to adhere to the surface of an inanimate object. Once the patch is applied it emulates the texture of any surface and it is immediately ready for paint. The thin property of the aluminum or aluminum foil creates a repair that blends seamlessly with any type of surface texture and the inherent rustproof characteristics make for a long-lasting repair. As soon as the repair wrap has been adhered to the surface of an object the repair is complete. There are no additional joint compounds, textures, or sanding required. The high performing adhesive holds firmly to create permanent repairs but with some effort it may be removed in the future if required.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A repair patch for covering holes in inanimate objects (eg: drywall, doors, wood, exterior siding) comprising: aluminum or aluminum foil, circular or of any other shape with a paper covered adhesive backer on one side. The repair patch is placed against the undamaged surface of an inanimate object aluminum side out and rubbed vigorously to imprint the texture of the surface into the aluminum. The paper covering the adhesive backer is removed and the adhesive side is pointed toward the surface of the inanimate object and centered over the hole, then placed onto the surface thereby covering the hole. Rubbing around the edges of the repair patch the aluminum or aluminum foil bonds to the surface and visually repairs the hole by replicating the surface of the inanimate object.
